(19) United States
(12) Patent Application Publication
(10) Pub. No.: US 2006/0219113 A1
(43) Pub. Date: Oct. 5, 2006

(54) IMAGE-FORMING APPARATUS

(75) Inventor: Mitsuhiro Mukasa, Ibaraki (JP)

Correspondence Address: DELLETT & WALTERS, P. O. BOX 82788, PORTLAND, OR, 97282-0788, US

(73) Assignee: Canon Finetech Inc., Ibaraki (JP)

(21) Appl. No.: 11/278,744

(22) Filed: Apr. 5, 2006

(30) Foreign Application Priority Data
Apr. 5, 2005 (JP) 2005-108586

(51) Int. Cl. B41F 5/02

(52) U.S. Cl. 101/231

(57) ABSTRACT

The printer assembly 60 of the image-forming apparatus 20 has a right side plate 200R and a left side plate 200L apart-at a predetermined distance in the sheet width direction (arrow-W direction) perpendicular to the delivery direction of the cut paper sheet P (arrow-A direction and arrow-B direction in FIG. 2). A first delivery pathway and a second delivery pathway are placed between the right side plate 200R and the left side plate 200L (in the space between the side plates). Two openings are formed on the right side plate 200R. The space between the opening 201 and the left side plate 200L serves as the first printer-unit room 81 for placing the printer unit 91. The space between the opening 202 and the left side plate 200L serves as the second printer-unit room 82 for placing the printer unit 92.

### TECHNICAL FIELD

The present invention relates to an image-forming apparatus having a U-turn path.

### TECHNICAL BACKGROUND

Image-forming apparatuses are known which have a so-called U-turn path and form an image on a recording medium sheet delivered through the U-turn path. The term “U-turn path” herein signifies a delivery path constituted of a first delivery pathway for delivering a recording medium sheet in a prescribed first direction and a second delivery pathway connected to the downstream end of the first delivery pathway and curved for delivering the recording medium sheet in a second direction reverse to the first direction. Various image-forming apparatuses are known which have the U-turn path for improving the space efficiency and throughput (e.g., Japanese Patent Application Laid-Open No. 2003-305893).

An example of the known image-forming apparatuses is explained by reference to FIG. 11.

FIG. 11 illustrates schematically an example of the conventional image-forming apparatus having a U-turn path.

The conventional image-forming apparatus 10 comprises a paper sheet-feeder unit 12 for feeding piled recording paper sheets P one by one, and printer units 14,16 for forming an image on the recording medium sheet delivered from the paper sheet-feeder unit 12. The sheet-feeder unit 12, the printer unit 14, and the printer unit 16 are separable from each other, and are used in a stacked state. The sheet-feeder unit 12 includes a delivery pathway 12a for delivering the recording medium sheet to the printer unit 14. The printer unit 14 includes a delivery pathway 14a connected to the delivery pathway 12a, delivery rollers 14b for delivering the recording medium sheet, and a printing member 14c for forming an image on the recording medium sheet. The printer unit 16 includes a delivery pathway 16a connected to the delivery pathway 14a, delivery rollers 16b for delivering the recording medium sheet, and printing member 16c for forming an image on the recording medium sheet.

By re-assembling the above sheet-feeder unit 12 and the printer units 14,16, various printers can be assembled such as a printer for single-side printing, and a printer for double-side printing.

However, the above-mentioned conventional image-forming apparatus 10 such as a printer for double-side printing constituted of the same printer units stacked has disadvantages of complexity of the delivery path, liableness to cause sheet jamming frequently, and a high cost of the apparatus. For simplification of the delivery path, the printer units of the same constitution cannot be used in a stacked state, necessitating development of plural kinds of printer units. This development will take a long time, increase the plant investment, and complicate the assemblage, disadvantageously.

### DISCLOSURE OF THE INVENTION

Under the above circumstances, the present invention intends to provide an image-forming apparatus which is assembled readily and is capable of conducting a single-sided printing and a double-sided printing.

For achieving the above object, the image-forming apparatus of the present invention having a U-turn path constituted of a first delivery pathway for delivering a recording medium sheet in a first direction and a second delivery pathway connected to the downstream side of the first delivery pathway and curved for delivering the recording medium sheet in a second direction reverse to the first direction, and forming an image on the recording medium sheet delivered through the first delivery pathway and the second delivery pathway,

the image-forming apparatus comprising

(1) a first printer-unit room for loading removably a first printer unit for image formation on the recording medium sheet delivered through the first delivery pathway, and
(2) a second printer-unit room for loading removably a second printer unit for image formation on the recording medium sheet delivered through the second delivery pathway.
(3) The first printer-unit room may be provided at the position for formation of an image on a front face of the recording medium delivered through the first delivery pathway, and
(4) the second printer-unit room may be provided at the position for formation of an image on a face reverse to the front face of the recording medium delivered through the second delivery pathway.
(5) The first printer unit and the second printer unit may have the same shape or the same structure.
(6) The first printer-unit room may allow loading and unloading of the first printer unit in the direction of the sheet width direction perpendicular to the first direction.
(7) The second printer-unit room may allow loading and unloading of the second printer unit in the direction of the sheet width direction perpendicular to the second direction.
(8) The first printer-unit room may allow loading of the first printer unit from the side opposite to the side of loading of the second printer unit in the second printer-unit room.
(9) The first printer unit and the second printer unit form an image by ejection of an ink on a recording medium.
(10) The first printer unit and the second printer unit form an image by forming a developed image by use of a developing agent on the recording medium sheet.

### BRIEF DESCRIPTION OF THE DRAWINGS

FIG. 1 is a perspective view of an image-forming apparatus of the present invention.

FIG. 2 illustrates schematically an internal structure of the image-forming apparatus shown in FIG. 1.

FIG. 3 is a perspective view illustrating a printer unit.

FIG. 4 is a block diagram showing a control system of the image-forming apparatus.

FIG. 5 is a flow chart showing outline of recording process with the image-forming apparatus.

FIG. 6 is a perspective view of the printer unit for printing on the front face of the delivered cut paper sheet, immediately before insertion into the first printer-unit room.

FIG. 7 is a perspective view of the printer unit placed in the first printer-unit room.

FIG. 8 is a perspective view the printer unit for printing on the reverse face of the delivered cut paper sheet, immediately before loading into the second printer-unit room.

FIG. 9 is a perspective view of the printer unit loaded into the second printer-unit room.

FIG. 10 is a perspective view showing the internal structure of the printer capable of setting simultaneously printer units in the first printer-unit room and the second printer-unit room.

FIG. 11 is a schematic drawing showing a conventional image-forming apparatus having a U-turn path.

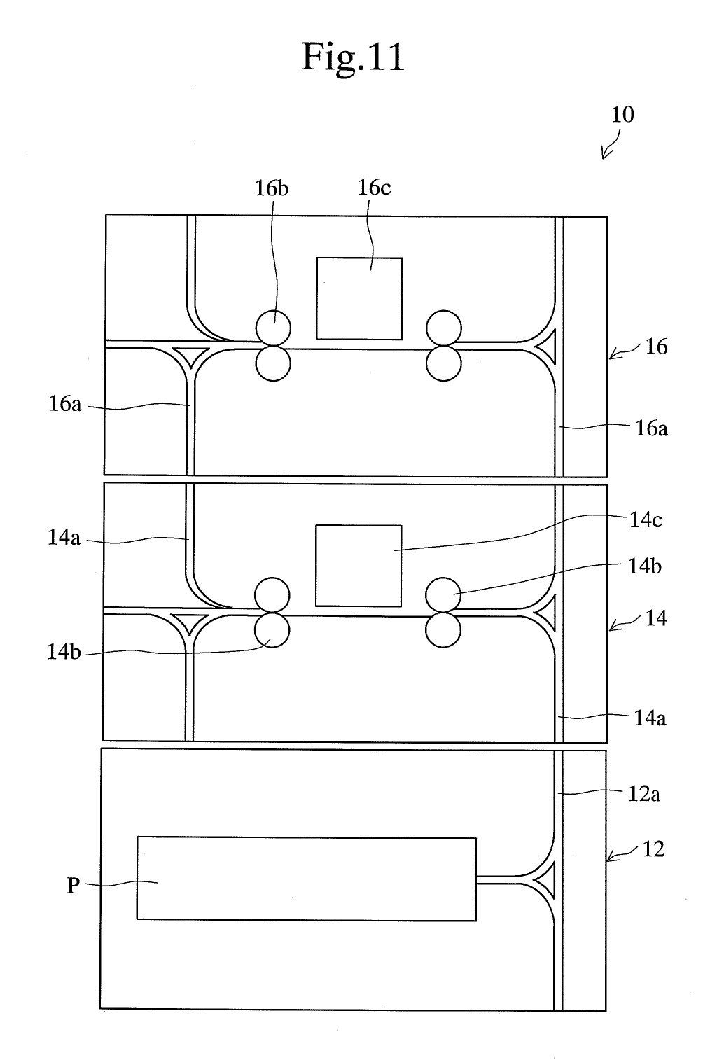

### BEST MODE FOR CARRYING OUT THE INVENTION

The present invention is realized in an inkjet type image-forming apparatus for formation of an image by ejecting an ink onto a recording medium.

### EXAMPLE 1

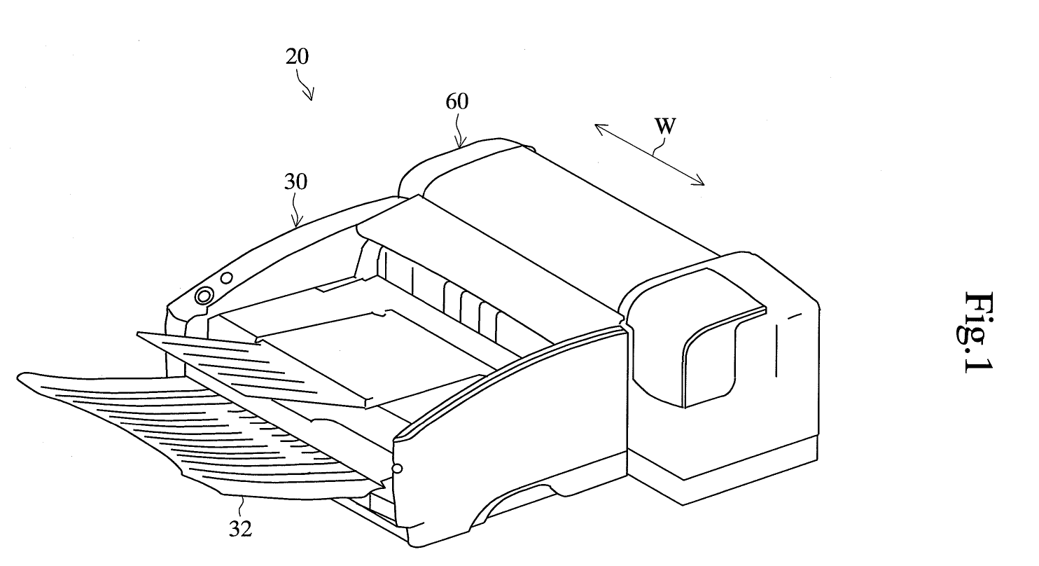

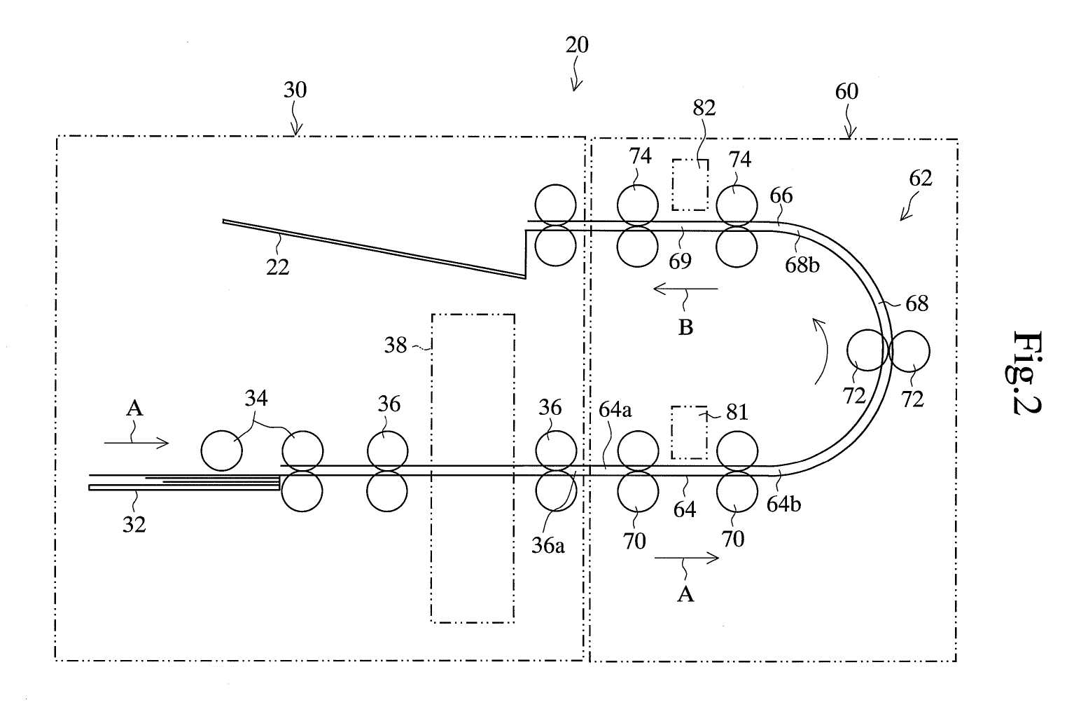

An example of the image-forming apparatus of the present invention is explained by reference to FIG. 1 and FIG. 2. FIG. 1 is a perspective view of an image-forming apparatus of the present invention. FIG. 2 illustrates schematically an internal structure of the image-forming apparatus shown in FIG. 1. In Example, 1, a scanner assembly 30 for reading an image on a ticket (traffic tickets, entertainment tickets, and the like; hereinafter referred to as a cut paper sheet) is provided at the upstream side of the printer assembly 60 in the sheet delivery direction. However, a device other than the scanner assembly 30 (e.g., a sheet-feeder unit for feeding the recording medium sheet) may be combined with the printer assembly 60.

The image-forming apparatus 20 is roughly constituted of a scanner assembly 30 for reading an image formed on a cut paper sheet P (an example of a recording medium sheet of the present invention), and a printer assembly 60 for printing an image on the cut paper sheet P carrying the image read by the scanner assembly 30.

The scanner assembly 30 comprises a tray 32 for holding cut paper sheets P, sheet-feeding rollers 34 for feeding the cut paper sheets P one by one, and a delivery rollers 36 for delivering the cut paper sheet P fed by the sheet-feeding roller 34 to the printer assembly 60. The delivery rollers 36 are driven by a delivery motor (not shown in the drawing). The image on the cut paper sheet P fed by sheet-feeding rollers 34 is read by the scanner unit 38. The scanner unit 38 may be of an optical type or a magnetic type.

In the printer assembly 60, a U-turn path 62 is provided to allow U-turn of the cut paper sheet P delivered from the scanner assembly 30. This U-turn path 62 comprises a first delivery pathway 64 for delivering the cut paper sheet P in the arrow-A direction (delivery direction) and a second delivery pathway 66 curved from the downstream side of the first delivery pathway 64 for delivering the cut paper sheet P in the arrow-B direction. The arrow-B direction is reverse to the arrow-A direction.

The upstream portion 64a of the first delivery pathway 64 is connected to the delivery path of the cut paper sheet P delivered by the delivery roller 36, and the downstream portion 64b thereof is connected to the second delivery pathway 66. The first delivery pathway 64 is a horizontal guide extending in the arrow-A direction for guiding the cut paper sheet P in the arrow-A direction. On the sides of first delivery pathway 64, plural pairs of delivery rollers 70 are installed for pinching and delivering the cut paper sheet P placed in this first delivery pathway.

The second delivery pathway 66 is connected to the downstream portion 64b of the first delivery pathway 64, being constituted of a U-turn guide 68 for guiding the cut paper sheet P having passed the downstream portion 64b to U-turn, and a horizontal guide 69 connected to the downstream portion 68b of the U-turn guide 68 and extending in the arrow-B direction. The horizontal guide 69 guides the cut paper sheet P in the arrow-B direction. On the sides of the U-turn guide 68, delivery rollers 72 are installed to pinch and deliver the cut paper sheet P. On the side of the horizontal guide 69, plural pairs of delivery rollers 74 are installed for pinching and delivering the cut paper sheet P. The delivery rollers 70,72,74 are driven by a delivery motor for driving the delivery rollers 36 of the scanner assembly 30 synchronously with the delivery rollers 36.

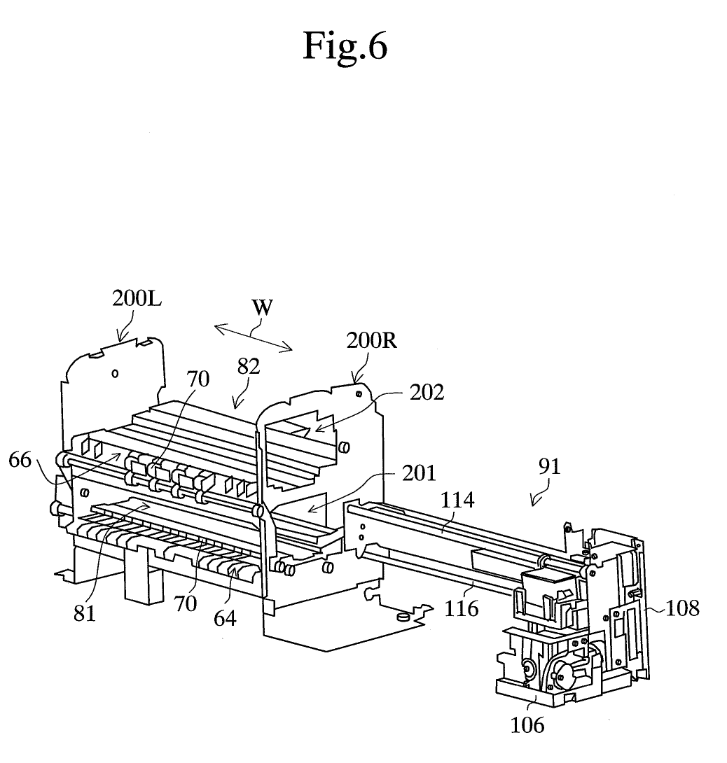

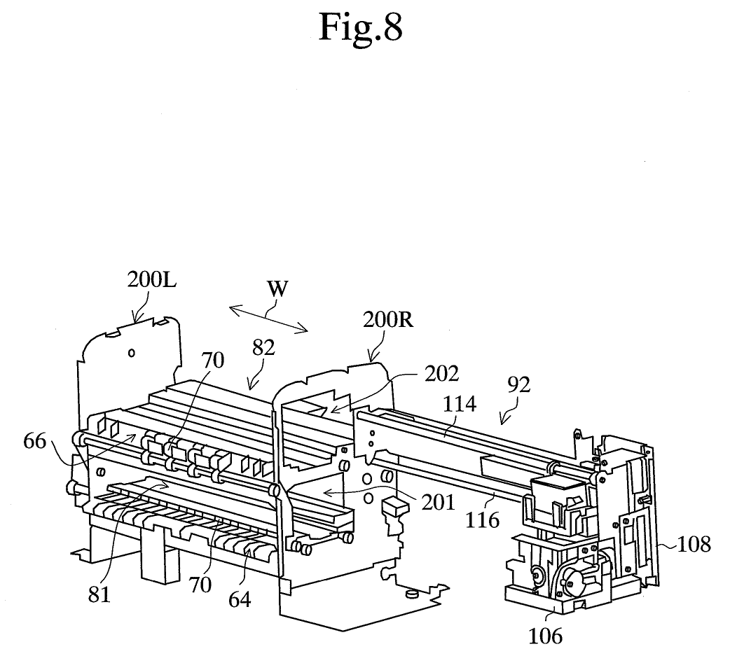

Above the middle of the first delivery pathway 64, a first printer-unit room 81 is provided for loading a first printer unit 91 (FIG. 6) removably for forming an image on a cut paper sheet P being delivered through this first delivery pathway 64. Above the middle of the second delivery pathway 66, a second printer-unit room 82 is provided for loading a second printer unit 92 (FIG. 8) removably for forming an image on a cut paper sheet P being delivered through this second delivery pathway 66. The first printer unit 91 is loaded removably into the first printer-unit room 81 in the direction of the paper sheet width (arrow-W direction in FIG. 1) perpendicular to the arrow-A direction. Similarly, the second printer unit 92 is loaded remobably into the second printer-unit room 82 in the direction of the paper sheet width (arrow-W direction in FIG. 1) perpendicular to the arrow-B direction.

When the first printer unit 91 is loaded into the first printer-unit room 81 and the second printer unit 92 is not loaded into the second printer-unit room 82, an image is formed only on the front face of the cut paper sheet P being delivered through the first delivery pathway 64. When the second printer unit 92 is loaded into the second printer-unit room 82 and the first printer unit 91 is not loaded into the first printer-unit room 81, an image is formed only on the reverse face of the cut paper sheet P being delivered through the second delivery pathway 66. When the first printer unit 91 is loaded into the first printer-unit room 81 and the second printer unit 92 is loaded into the second printer-unit room 82, an image is formed on the front face of the cut paper sheet P being delivered through the first delivery pathway 64, and successively an image is formed on the reverse face of the cut paper sheet P being delivered through the second delivery pathway 66 (images being printed on the both faces).

The delivery of the cut paper sheet P is explained below.

The cut paper sheets P piled in a tray 32 are delivered one by one in the arrow-A direction by a sheet-feeding rollers 34 to the scanner unit 38. There, the image on the cut paper sheet P is read by the scanner unit 38. The cut paper sheet P is then delivered to the printer assembly 60. In the printer assembly 60, the cut paper sheet P is delivered through the first delivery pathway 64. When the first printer unit 91 is loaded into the first printer-unit room 81, an image (e.g., dates) corresponding to the image read by the scanner unit 38 is formed on the front face of the cut paper sheet P being delivered through the first delivery pathway 64. The cut paper sheet P having passed through the first delivery pathway 64 is allowed to U-turn by the U-turn guide 68 and the delivery roller 72 and is delivered to the second delivery pathway 66. When the second printer unit 92 is loaded into the second printer-unit room 82, an image (e.g., dates) corresponding to the image read by the scanner unit 38 is formed on the reverse face of the cut paper sheet P being delivered through the second delivery pathway 66.

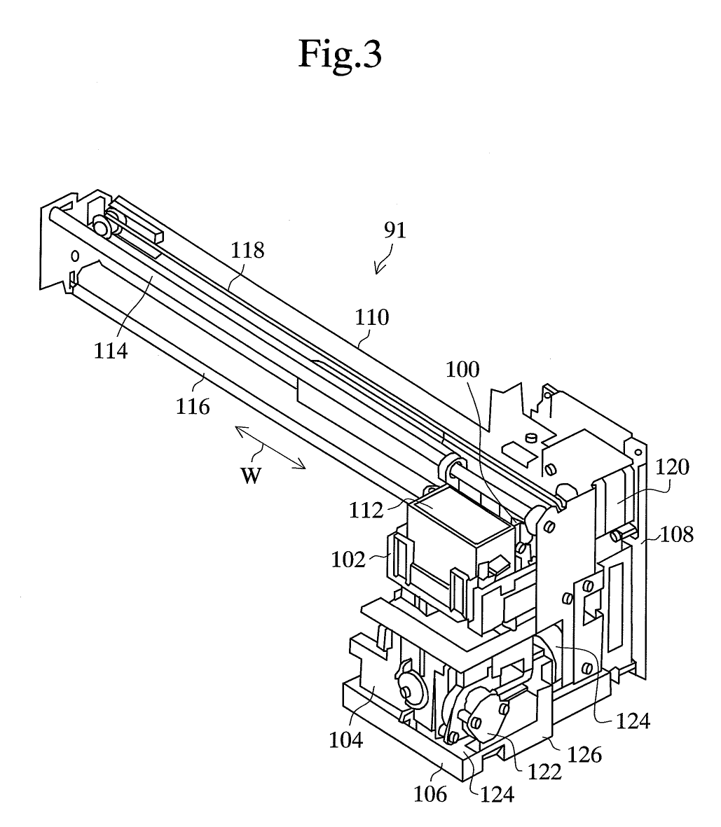

The printer units 91,92 are explained by reference to FIG. 3.

FIG. 3 is a perspective view illustrating the printer unit. Since the two printer units 91,92 are the same in the structure, shape, and size, the printer unit 91 is explained.

The printer unit 91 has a printer main frame 110 extending in the paper sheet width direction (arrow-W direction). On one end in the length direction of the printer main frame 110, are attached a recording head (printing head) 100, a carriage 102, a recovery device 104, a waste-liquid recovery unit 106, and a control board 108. On the recording head 100, plural nozzles are formed for ejection of the ink, and an ink tank 112 is set detachably near the nozzles. The recording head 100 and the ink tank 112 are set detachably on the carriage 102.

The carriage 102 is guided by two carriage shafts 114,116 to move in the arrow W directions. The carriage 102 is attached to a timing belt 118. The timing belt 118 and the carriage 102 are driven in the arrow-W directions by a carriage motor 120. The carriage 102 is moved in the range from the position opposing the recovery device 104 to the other end. The recovery device 104 is constituted of a cap (not shown in the drawing), a blade (not shown in the drawing), and a pump 122. These members together with the pump 122 are driven by the recovery motor 124. The recovery device 104 cleans the recording head 100, and prevents the nozzle from drying during the standby state of the recording head. The waste liquid recovery unit 106 has a recovery vessel 126 containing an absorbent material 124 for absorbing the ink discharged from the pump 122 of the recovery device 104 during the cleaning of the recording head 100. The control board 108 serves to control the printing operation of the recording head 100, and to control the carriage 102 and the recovery unit 104.

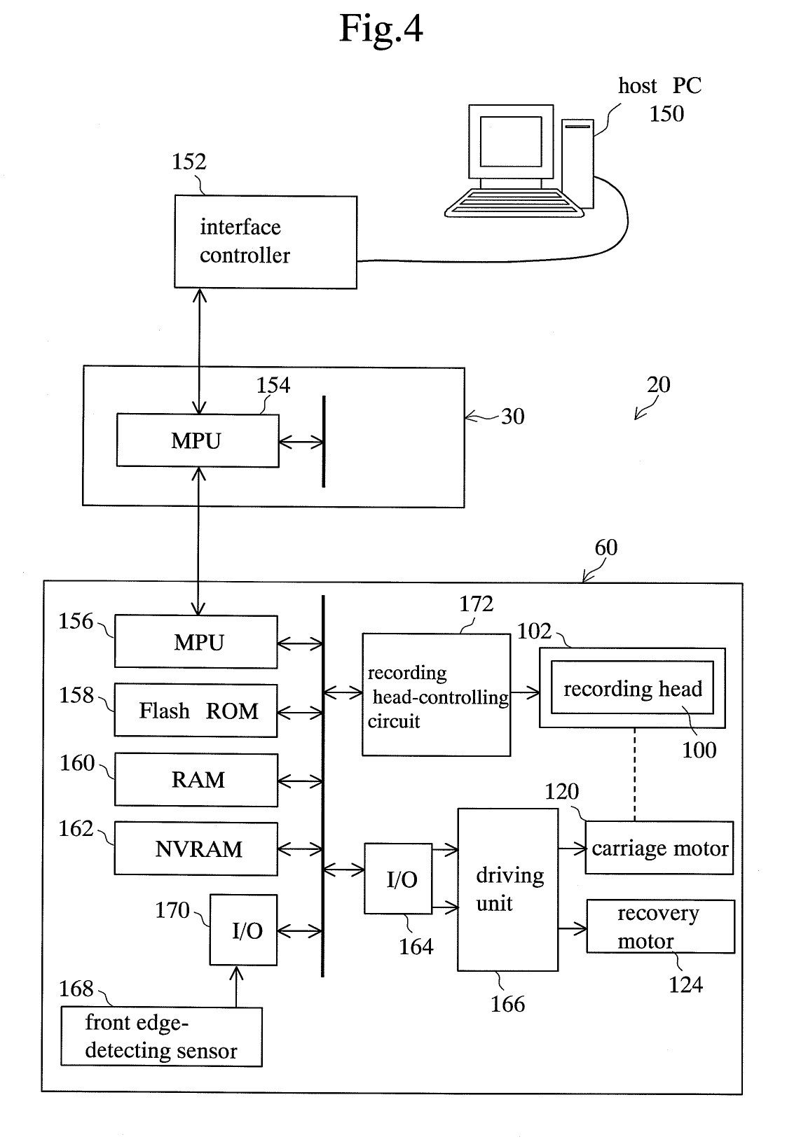

The control system for the image-forming apparatus 20 is explained by reference to FIG. 4.

FIG. 4 is a block diagram showing the control system of the image-forming apparatus.

A host computer 150 (host PC, hereinafter referred simply to as a host) transmits the recording data generated by the host 150 through an interface controller 152 of the image-forming apparatus 20 to the scanner assembly 30. This recording data is transmitted from the MPU 154 of the scanner assembly 30 by serial communication to a MPU 156 of a control board 108 (FIG. 3) to instruct the start of the recording. The MPU 156 controls the recording by reading out the program from the flash ROM 158 memorized preliminarily corresponding to the flow chart mentioned later. The MPU 156, after analyzing the command received from the host 150, writes the recording data in the RAM 160 and memorizes it temporarily. The NVRAM 162 stores adjusted values and preset values inherent to the image-forming apparatus 20, and holds the information even when the power source of the image-forming apparatus 20 is disconnected, and the contents of the information are changeable.

The carriage 102 holding the recording head 100 and the ink tank 112 is moved to the home position or the recording position by the carriage motor 120. When instruction for printing onto an original document is outputted from the scanner assembly 30, the carriage motor 120 is driven through the input-output port 164 and the driving unit 166 to move the carriage 102 to the recording position. On delivery of the original document from the scanner assembly 30 to the printer assembly 60, the front edge of the original document is detected by a front edge-detecting sensor 168 placed at the upstream portion 64a of the first delivery pathway 64 (FIG. 2). The information of the detection is transmitted through the input-output port (I/O) 170 and the MPU 156 to the MPU 154. Immediately thereafter, the image formation signal is transmitted from the MPU 154 to the MPU 156. Thereby, the recording data memorized in the RAM 160 is transmitted through the recording head-controlling circuit 172 to the recording head 100 to form an image (to record the information) on the cut paper sheet P. The recovery device 104 and the pump mechanism (not shown in the drawing) can be driven selectively by drive control of the recovery motor 124 through the input-output port 164 and the driving unit 166. In this Example, a stepping motor rotatable removably is useful as the recovery motor 124 and the carriage motor 120.

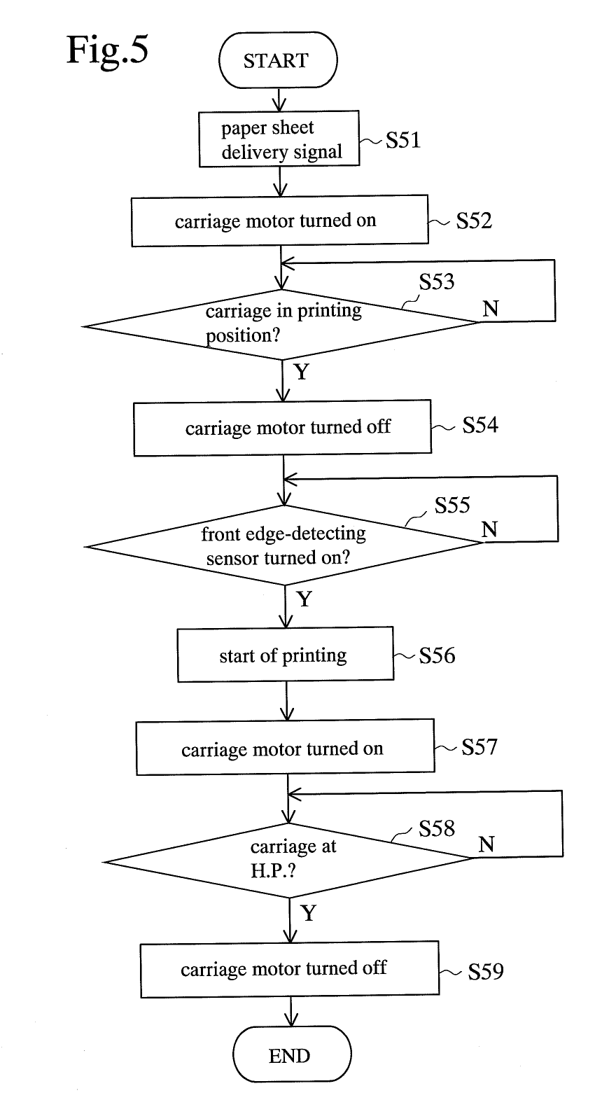

The recording process with the image-forming apparatus 20 having the constitution mentioned above is explained by reference to FIG. 5.

FIG. 5 is a flow chart showing outline of the recording process with the image-forming apparatus 20.

The flow is started by turning on the main switch of the image-forming apparatus 20. On reception of the signal of paper sheet delivery to the scanner assembly 30 (FIG. 1) (S51), the carriage motor 120 is started (S52) to move the carriage 102. The movement of the carriage 102 to the printing position (recording position) is judged (S53) from the signal from the detecting sensor (not shown in the drawing) for detecting the carriage 102. On judgment of the recording position of the carriage 102, the carriage motor 120 is turned off (S54). Then the detection of the original document delivered from the scanner assembly 30 by the front edge-detecting sensor 168 (FIG. 4) is judged (S55). On judging the detection of the original document by the front edge-detecting sensor 168, the recording is started by ejecting the ink from the recording head 100 onto the original document at the prescribed timing (S56). When printing on a prescribed number of the sheets has been completed, the carriage motor 120 is started (S57). Thereby the carriage motor 120 moves the carriage 102 to the position opposing the recovery device 104 (home position: H.P.). Successively, the arrival of the carriage 102 at the home position is judged (S58). When the carriage 102 is judged to be at the home position, the carriage motor 120 is turned off (S59). The completion of the flow finishes a series of the image formation operation.

The internal structure of the printer assembly 60 is explained by reference to FIGS. 6-9.

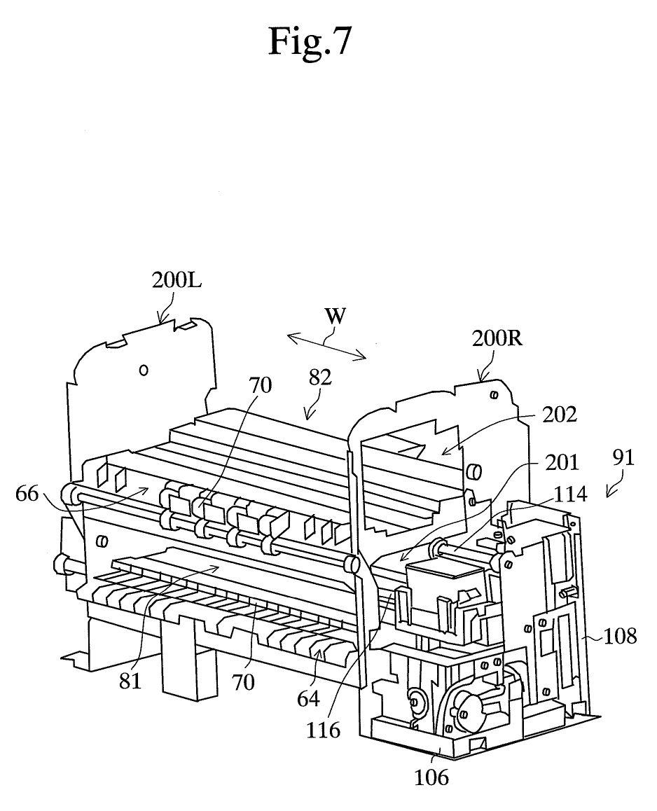

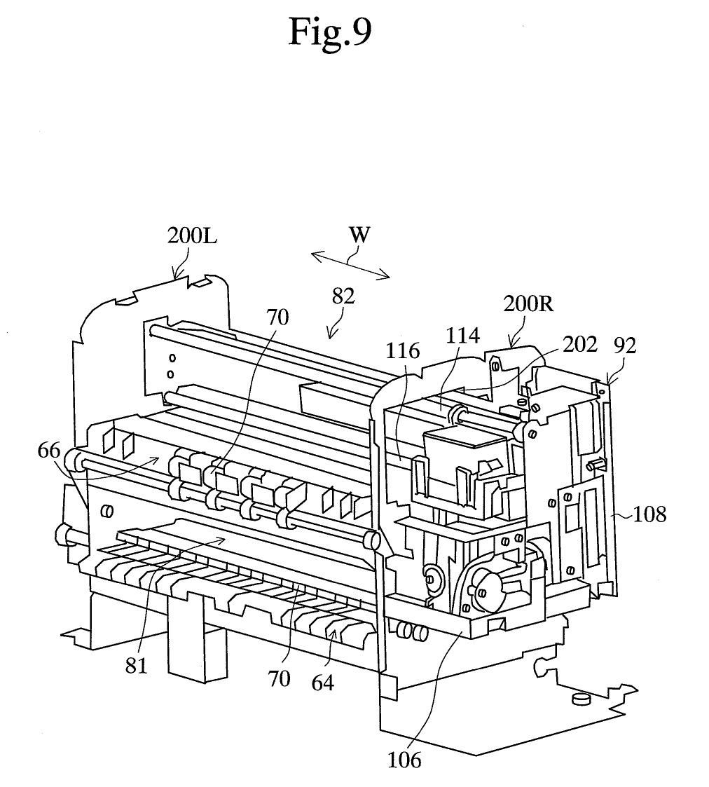

FIG. 6 is a perspective view of the printer unit for printing on the front face of the delivered cut paper sheet, immediately before loading into the first printer-unit room. FIG. 7 is a perspective view of the printer unit placed in the first printer-unit room. FIG. 8 is a perspective view of the printer unit for printing on the reverse face of the delivered cut paper sheet, immediately before loading into the second printer-unit room. FIG. 9 is a perspective view of the printer unit placed in the second printer-unit room.

The printer assembly 60 of the image-forming apparatus 20 has a right side plate 200R and a left side plate 200L apart at a predetermined distance in the sheet width direction (arrow-W direction) perpendicular to the delivery direction of the cut paper sheet P (arrow-A direction and arrow-B direction in FIG. 2). This distance is slightly shorter than the width of the printer assembly 60 (length in the arrow-W direction). A first delivery pathway 64 and a second delivery pathway 66 are provided between the right side plate 200R and the left side plate 200L (in the space between the two side plates).

Two openings 201,202 are formed on the right side plate 200R. The opening 201 is placed lower than the opening 202: the opening 202 is placed higher than the opening 201. The space between the opening 201 and the left side plate 200L serves as the first printer-unit room 81 for loading the printer unit 91. The space between the opening 202 and the left side plate 200L serves as the second printer-unit room 82 for loading the printer unit 92. The first printer-unit room 81 is formed above the horizontal guide at the upstream side of a U-turn guide 68 (FIG. 2) in the cut paper sheet delivery direction: the second printer-unit room 82 is formed above a horizontal guide 69 at the downstream side of the U-turn guide 68 in the cut paper sheet delivery direction. Incidentally, on the left side plate 200L, no opening is formed for loading the printer units 91,92.

For loading the printer unit 91 into the first printer-unit room 81, the printer unit 91 is inserted through the opening 201 into the first printer-unit room 81, and the tips of the carriage shafts 114,116 of the printer unit 91 are fitted to holes on the left side plate 200L to decide the position. In this state, the printer unit 91 is fixed to the right side plate 200R and to the left side plate 200L with screws or the like. Similarly, for loading the printer unit 92 into the second printer-unit room 82, the printer unit 92 is inserted through the opening 202 into the second printer-unit room 82, and the tips of the carriage shafts 114,116 of the printer unit 92 are fitted to holes on the left side plate 200L to decide the position. In this state, the printer unit 92 is fixed to the right side plate 200R and to the left side plate 200L with screws or the like. In this Example, two openings 201,202 are provided on one common right side plate 200R. Instead, separate side plates may be provided: one for the printer unit 91 for printing on the front face of the cut paper sheet P, and another for the printer unit 92 for printing on the reverse face of the cut paper sheet P, each of the side plates having one opening. In this constitution, the side plates for the printer for printing on the front face of the cut paper sheet P can be made smaller in the height direction to save the space of the printer assembly 60.

In the above Example, since the printer units 91,92 are large in size, the printer unit 91 and the printer unit 92 cannot be placed simultaneously in the first printer-unit room 81 and the second printer-unit room 82 respectively. An example is explained below in which the printer units 91,92 can be placed simultaneously in the first printer-unit room 81 and the second printer-unit room 82 even though the sizes of the printer units 91,92 are large.

### EXAMPLE 2

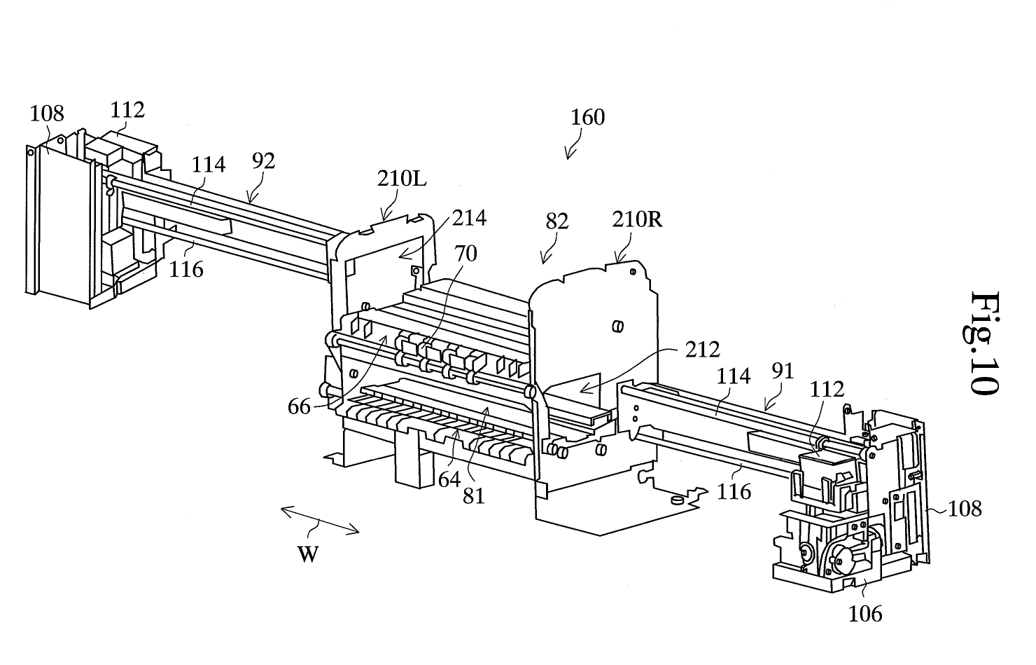

A printer is explained in which two printer units 91,92 can respectively be placed simultaneously in a first printer-unit room 81 and a second printer-unit room 82 by reference to FIG. 10.

FIG. 10 is a perspective view showing the internal structure of the printer in which two printer units can respectively be loaded simultaneously into the first printer-unit room and the second printer-unit room. In FIG. 10, the same symbols are used as in FIGS. 6-9 for indicating the corresponding constituting elements.

The printer 160 has a right side plate 200R and a left side plate 200L apart at a predetermined distance in the sheet width direction (arrow W direction) perpendicular to the delivery direction of the cut paper sheet P (arrow-A direction and arrow-B direction in FIG. 2). This distance is slightly shorter than the width of the printer 160 (length in the arrow-W direction). A first delivery pathway 64 and a second delivery pathway 66 are formed between the right side plate 200R and the left side plate 200L (in the space between the two side plates).

In the right side plate 210R, an opening 212 is formed on the portion facing the right side of the first delivery pathway 64. In the left side plate 210L, another opening 214 is formed on the portion facing the left side of the second delivery pathway 66. The space between the opening 212 and the left side plate 210L serves as the first printer-unit room 81 for placing the printer unit 91. The space between the opening 214 and the right side plate 210R serves as the second printer-unit room 82 for placing the printer unit 92. The first printer-unit room 81 is provided above the horizontal guide at the upstream side of a U-turn guide 68 (FIG. 2) in the cut paper sheet delivery direction: the second printer-unit room 82 is provided above a horizontal guide 69 at the downstream side of the U-turn guide 68 in the cut paper sheet delivery direction.

For placing the printer unit 91 in the first printer-unit room 81, the printer unit 91 is inserted through the opening 212 into the first printer-unit room 81, and the tips of the carriage shafts 114,116 are fitted to holes on the left side plate 210L to decide the position. In this state, the printer unit 91 is fixed to the right side plate 210R and to the left side plate 210L with screws or the like. Similarly, for loading the printer unit 92 into the second printer-unit room 82, the printer unit 92 is inserted through the opening 214 into the second printer-unit room 82, and the tips of the carriage shafts 114,116 of the printer unit 92 are fitted to holes on the right side plate 212R to decide the position. In this state, the printer unit 92 is fixed to the right side plate 210R and to the left side plate 210L with screws or the like. Incidentally, the printer unit 92 is inserted in the insertion direction reverse to that of the printer unit 91 through the opening 214 on the left side plate 210L.

With the above constitution, both of the printer units 91,92 of the same shape can be loaded simultaneously into a printer 160 to conduct printing on both faces of a cut paper sheet P. With the printer unit 91 loaded into the first printer-unit room 81 without the printer unit 92 in the second printer-unit room 82, the printing is conducted only on the front face of the cut paper sheet P, whereas without the printer unit 91 in the first printer-unit room 81 with the printer unit 92 loaded into the second printer-unit room 82, the printing is conducted only on the reverse face of the cut paper sheet P. With this constitution, one printer 160 can serve as three types of printers for printing on the front face, the reverse face, and the both faces of the cut paper sheets P. This enables shortening of the development period, saving of the equipment investment, and simplification of the assemblage of the printer.

In the above description, the printer units are explained which form an image by ejection of an ink onto a recording medium. However, the printer units may be those which form images by development by use of a developing agent.

As described above, according to the present invention, with the first printer unit loaded into the first printer-unit room without loading of the second printer unit into the second printer-unit room (or with the loading relation reversed), the image is formed only on one face side (the front face or the reverse face) of the recording medium. With the first printer unit loaded into the first printer-unit room for image formation on the front face (or the reverse face) of the recording medium and with the second printer unit loaded into the second printer-unit room for image formation on the reverse face (or the front face) of the recording medium, the image is formed on the both faces of the recording medium. In such a manner, one-face printing and both-face printing can be selectively conducted by selective loading of the printer units into the first printer-unit room and the second printer-unit room. Thus image-forming apparatuses of a one-face print type or a both-face print type can be simply assembled by loading the printer unit or units into one or both of the first printer-unit room and the second printer-unit room in the manufacture of the image-forming apparatus before shipment.

1. An image-forming apparatus having a U-turn path constituted of a first delivery pathway for delivering a recording medium sheet in a first direction and a second delivery pathway connected to the downstream side of the first delivery pathway and curved for delivering the recording medium sheet in a second direction reverse to the first direction, and forming an image on the recording medium sheet delivered through the first delivery pathway and the second delivery pathway,
the image-forming apparatus comprising
a first printer-unit room for loading removably a first printer unit for image formation on the recording medium sheet delivered through the first delivery pathway, and
a second printer-unit room for loading removably a second printer unit for image formation on the recording medium sheet delivered through the second delivery pathway.

2. The image-forming apparatus according to claim 1, wherein the first printer-unit room is provided at the position for formation of an image on a front face of the recording medium delivered through the first delivery pathway, and
the second printer-unit room is provided at the position for formation of an image on a face reverse to the front face of the recording medium delivered through the second delivery pathway.

3. The image-forming apparatus according to claim 1, wherein the first printer unit and the second printer unit have the same shape or the same structure.

4. The image-forming apparatus according to claim 1, wherein the first printer-unit room allows loading and unloading of the first printer unit in the direction of the sheet width direction perpendicular to the first direction.

5. The image-forming apparatus according to claim 1, wherein the second printer-unit room allows loading and unloading of the second printer unit in the direction of the sheet width direction perpendicular to the second direction.

6. The image-forming apparatus according to claim 5, wherein the first printer-unit room allows loading of the first printer unit from the side opposite to the side of loading of the second printer unit into the second printer-unit room.

7. The image-forming apparatus according to claim 1, wherein the first printer unit and the second printer unit form images by ejection of an ink on a recording medium sheet.

8. The image-forming apparatus according to claim 1, wherein the first printer unit and the second printer unit form images by forming a developed image by use of a developing agent on the recording medium sheet.

9. The image-forming apparatus according to claim 2, wherein the first printer unit and the second printer unit have the same shape or the same structure.

10. The image-forming apparatus according to claim 2, wherein the first printer-unit room allows loading and unloading of the first printer unit in the direction of the sheet width direction perpendicular to the first direction.

11. The image-forming apparatus according to claim 3, wherein the first printer-unit room allows loading and unloading of the first printer unit in the direction of the sheet width direction perpendicular to the first direction.

12. The image-forming apparatus according to claim 2, wherein the second printer-unit room allows loading and unloading of the second printer unit in the direction of the sheet width direction perpendicular to the second direction.

13. The image-forming apparatus according to claim 3, wherein the second printer-unit room allows loading and unloading of the second printer unit in the direction of the sheet width direction perpendicular to the second direction.

14. The image-forming apparatus according to claim 2, wherein the second printer-unit room allows loading and unloading of the second printer unit in the direction of the sheet width direction perpendicular to the second direction.

15. The image-forming apparatus according to claim 4, wherein the first printer-unit room allows loading of the first printer unit from the side opposite to the side of loading of the second printer unit into the second printer-unit room.

15. The image-forming apparatus according to claim 1, wherein the first printer unit and the second printer unit form images by ejection of an ink on a recording medium sheet.

16. The image-forming apparatus according to claim 1, wherein the first printer unit and the second printer unit form images by ejection of an ink on a recording medium sheet.

18. The image-forming apparatus according to claim 1, wherein the first printer unit and the second printer unit form images by ejection of an ink on a recording medium sheet.

19. The image-forming apparatus according to claim 1, wherein the first printer unit and the second printer unit form images by ejection of an ink on a recording medium sheet.

20. The image-forming apparatus according to claim 1, wherein the first printer unit and the second printer unit form images by ejection of an ink on a recording medium sheet.
